(19) United States
(12) Patent Application Publication
(10) Pub. No.: US 2007/0080598 A1
(43) Pub. Date: Apr. 12, 2007

(54) Electric rotary machine

(75) Inventor: Yuji Naruse, Kanagawa (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/541,798

(22) Filed: Oct. 3, 2006

(30) Foreign Application Priority Data
Oct. 5, 2005 (JP) 2005-292474

(51) Int. Cl. H02K 21/12

(52) U.S. Cl. 310/156.56; 310/156.32; 310/156.48

(57) ABSTRACT

In an electric rotary machine of an axial gap type, at least one rotor including a rotor coreis provided, at least one stator is provided the at least one stator facing one surface of the at least one rotor with an axial gap therebetween, and a plurality of magnet groups is provided, each of the magnet groups comprising a plurality of magnets having the same polarities and being arranged in the rotor core to be mutually faced with each other in a radial direction of the rotor.

### BACKGROUND OF THE INVENTION

(a) Field of the Invention

The present invention relates to an electric rotary machine and, more particularly, relates to an axial gap electric rotary machine in which an increase in a reluctance torque is achieved.

(b) Description of the Related Art

A previously proposed axial gap electric rotary machine is exemplified by a Japanese Patent Application First Publication (tokkai) No. 2005-151725 published on Jun. 9, 2005 (which corresponds to a United States Patent Application Publication No. 2005/0179336 published on Aug. 18, 2005). In this axial gap electric rotary machine, magnetic materials are provided on parts of a surface of magnets (hereinafter, simply called the magnets in place of permanent magnets) of a rotor faced with an axial air gap to reduce a q-axis magnetic resistance (or q-axis reluctance), thus increasing the reluctance torque.

A magnet torque of a motor is, generally, in proportion to number of poles x magnetic fluxes of (permanent) magnets x current. Hence, it is effective to increase the reluctance torque by increasing the number of poles to become near to the number of slots. In addition, in order to increase the magnetic fluxes of the magnets, a method has been proposed such that the magnets are arranged in the electric rotary machine along its circumferential direction in an alphabetical letter V shape or a Japanese letter of Katakana [symbol] shape (approximately near to a 90° leftward rotated alphabetical letter of U). Such a letter V shaped magnet arrangement as described above or such a Japanese letter Katakana [symbol] shaped magnet arrangement as described above exhibits an advantage that the magnetic fluxes of the magnets are increased and exhibits another advantage that the q-axis magnetic resistance is reduced to obtain the reluctance torque.

### SUMMARY OF THE INVENTION

However, if the number of poles is increased, a circumferential length per pole is limited. Hence, if the magnets are arranged in the circumferential direction of the axial gap electric rotary machine in the letter V shapes or in the Japanese Katakana [symbol] shapes, a length of each pole in the circumferential direction cannot sufficiently be obtained. Thus, this results in a decrease in the magnetic fluxes of the magnets.

It is, therefore, an object of the present invention to provide an electric rotary machine which can simultaneously achieve the increase in the number of poles and the increase in the magnetic fluxes of magnets.

To achieve the above-described object, according to an aspect of the present invention, there is provided an electric rotary machine, comprising: at least one rotor including a rotor core; at least one stator, the at least one stator facing one surface of the at least one rotor with an axial gap therebetween; and a plurality of magnet groups, each magnet group comprising a plurality of magnets having the same polarities and being arranged in the rotor core to be mutually faced with each other in a radial direction of the rotor.

This summary of the invention does not necessarily describe all necessary features so that the present invention may also be a sub-combination of these described features. Other objects and advantages will be apparent from the ensuring specification and drawings.

### BRIEF DESCRIPTION OF THE DRAWINGS

FIG. 1A is a partial perspective view of a rotor as viewed from an axial (air) gap side in an electric rotary machine in a first preferred embodiment according to the present invention.

FIG. 1B is a cross sectional explanatory view of the electric rotary machine cut away along a rotation axis direction of the rotor shown in FIG. 1A as viewed from a radial direction of the rotor.

FIG. 1C is a partial plan explanatory view of the rotor shown in FIG. 1A as viewed from the axial (air) gap side.

FIG. 2A is a cross sectional explanatory view of the electric rotary machine cut away along the rotation axis direction of the rotor as viewed from the radial direction of the rotor representing a magnet arrangement in the rotor of the electric rotary machine in a case of a second preferred embodiment according to the present invention.

FIG. 2B is a partial plan explanatory view of a part of the rotor shown in FIG. 2A as viewed from the axial (air) gap side.

FIG. 3A is a cross sectional explanatory view of the electric rotary machine cut away along the rotation axis direction of the rotor as viewed from the radial direction of the rotor representing the magnet arrangement of the electric rotary machine in a case of a third preferred embodiment according to the present invention.

FIG. 3B is a partial plan explanatory view of the rotor shown in FIG. 3A as viewed from the axial (air) gap side.

FIG. 4A is a cross sectional view cut away along the rotation axis direction of the rotor as viewed from the radial direction of the rotor representing the magnet arrangement of the electric rotary machine in a fourth preferred embodiment according to the present invention.

FIG. 4B is a partial plan explanatory view of the rotor shown in FIG. 4A as viewed from the axial (air) gap side.

### DETAILED DESCRIPTION OF THE INVENTION

Reference will hereinafter be made to the drawings in order to facilitate a better understanding of the present invention.

Before explaining the present invention, a whole structure of the previously proposed axial gap electric rotary machine is exemplified by a United States Patent Application Publication No. US2005/0179336 published on Aug. 8, 2005.

### First Embodiment

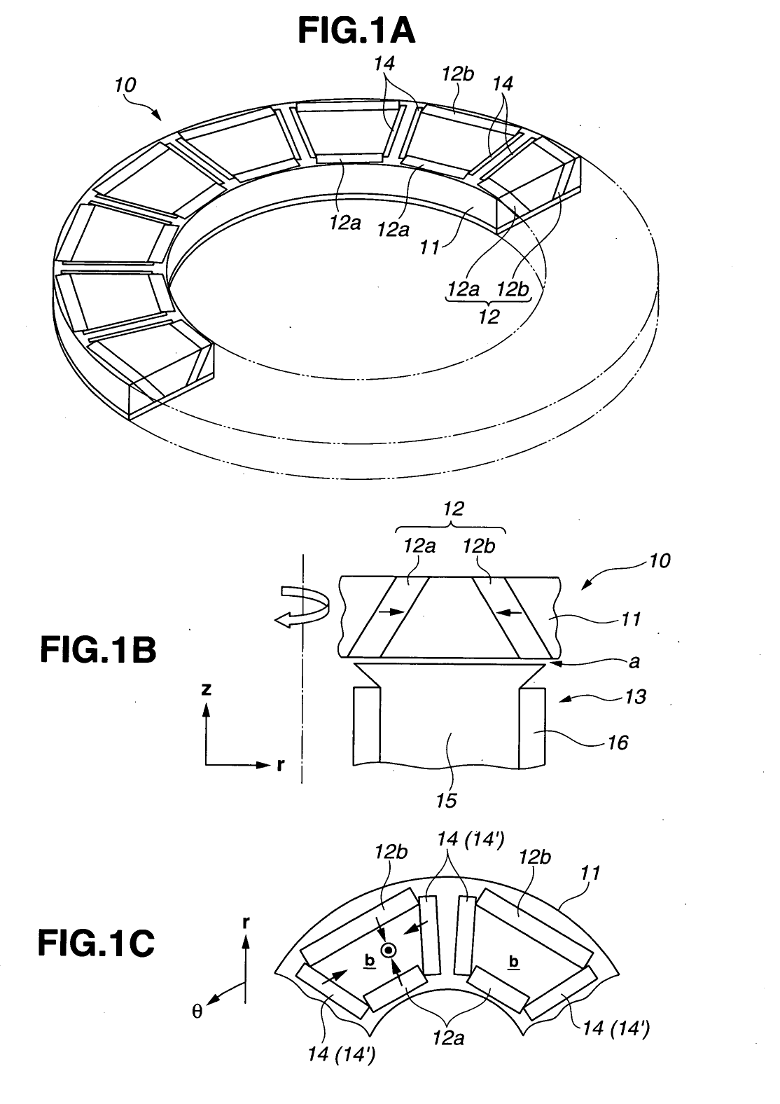

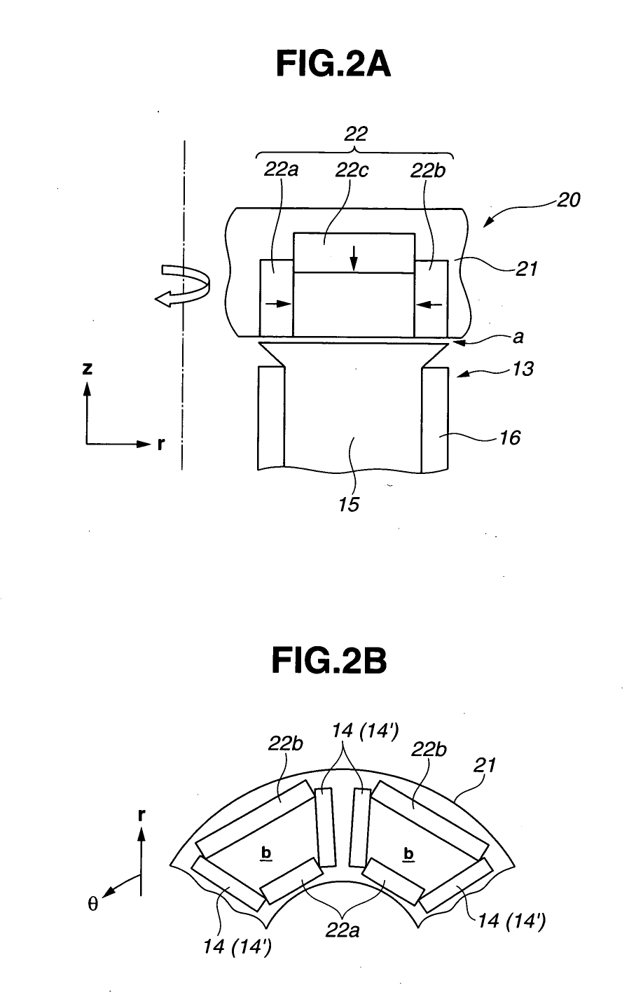

FIGS. 1A, 1B, and 1C integrally show an arrangement of magnets in a rotor of an electric rotary machine in a first preferred embodiment according to the present invention. FIG. 1A is a partial perspective view of an arrangement of magnets in rotor 10 as viewed from an axial (air) gap a provided between rotor 10 and a stator 13 of the (axial gap) electric rotary machine. FIG. 1B is a cross sectional view of the electric rotary machine cut away along a rotation axis direction of rotor 10 shown in FIG. 1A. FIG. 1C is a partial plan explanatory view of rotor 10 as viewed from axial (air) gap a provided between rotor 10 and stator 13 of the electric rotary machine in the first embodiment. As shown in FIGS. 1A, 1B, and 1C, rotor 10 of the electric rotary machine is provided with a plurality of magnet groups 12, 12, 12, - - - mutually adjoined along a circumference (θ) direction of rotor 10, for example, and buried in an annular rotor core 11 made of steel plates (refer to FIG. 1A). This rotary machine is an axial gap electric rotary machine in which rotor 10 and stator 13 are arranged to face with each other via axial (air) gap a in an axial direction of the electric rotary machine. In FIG. 1B, arrow marks in a pair of magnets denote directions of magnetic fluxes in each of the pair of magnets and, in FIGS. 1B and 1C, r denote a radial direction of the rotor, z denotes the rotation axis direction of the rotor, and θ denotes a circumference direction of the rotor. These symbols are applicable to FIGS. 2A, 2B, 3A, 3B, 4A, 4B, 5A, and 5B. It is noted that a symbol • enclosed by a circle mark O shown in FIG. 1C denotes a direction of a magnetic field (a magnetic flux) vertically from a rear side of paper to a front side of paper (viz., to a stator side) located at a center between pair of magnets 12a, 12b and circumference directional magnets 14, 14 (air gaps 14′, 14′) of each of magnet groups 12.

Each magnet group 12 is constituted by pair of magnets 12a and 12b of the same polarities. Each of the pair of magnets 12a, 12b has a length reaching mutually opposite surfaces (or called front and rear surfaces) of rotor core 11. In the radial direction (r), both of pair of magnets 12a, 12b are arranged to mutually face with each other and are arranged in a Japanese letter of Katakana [symbol] , axial air gap side edges thereof being widened (refer to FIG. 1B). In addition, circumference directional magnets 14, 14 having the same polarities and whose same polarity poles are directed toward a center between the pair of magnets 12a, 12b in order for a direction of each of the poles having the same polarities to be toward the center of pair of magnets 12a, 12b are arranged at both circumferential ends of pair of magnets 12a, 12b in the circumference (θ) direction of rotor 10 (refer to FIGS. 1A and 1C). Each of magnet groups 12, 12, 12, - - - constituted by pair of magnets 12a, 12b and respective circumference directional magnets 14, 14 is arranged along the circumference (θ) direction of rotor 10, with the different polarities thereof alternated (N, S, N, S, - - - ).

On the other hand, stator 13 is provided with a plurality of teeth portions 15 projected from a stator core. A coil 16 is wound on each of teeth portions 15 (refer to FIG. 1B). Hence, pair of magnets 12a, 12b and both of circumference directional magnets 14, 14 are arranged in rotor core 11 in an approximately rectangular shape as viewed from a portion b of rotor core 11 facing each teeth portion 15 of stator 13. It is noted that, in place of circumference directional magnets 14, 14 having the same polarities, air gaps 14′, 14′ may be provided at the same locations of circumference directional magnets 14, 14 in rotor core 11.

As described above, each of pair of magnets 12a, 12b has the length reaching the front and rear (mutually opposite) surfaces of rotor core 11, the poles of the same polarities are mutually faced with each other (in a case of FIG. 1B, N (North) poles) and pair of magnets 12a, 12b are arranged, in order for a lower edge of each of pair of magnets 12a, 12b which faces axial (air) gap a to be wider than an upper edge of each of pair of magnets 12a, 12b which faces the opposite side to axial (air) gap a as in the Japanese letter of Katakana [symbol] shape as viewed from FIG. 1B. Hence, as compared with a surface magnet type in which the magnet is arranged on a surface of the rotor core, a surface area of each of pair of magnets 12a, 12b can be widened. Hence, large magnetic fluxes of magnets can be obtained. Especially, in a case where a difference in length between an inner diameter of rotor 10 and an outer diameter thereof is large, the magnetic fluxes of magnets can more effectively be obtained. Next, surface areas of both of magnets 12a, 12b can be larger than a projected area of both of magnets 12a, 12b on the rotor surface as viewed from rotor axis direction (z direction). Thus, large magnet magnetic fluxes can be obtained. In addition, when both of magnets 12a, 12b are arranged to face with each other in the circumference direction of the rotor, a volume of the rotor core between the mutually faced respective magnets becomes extremely small and the reluctance torque is accordingly reduced. However, in the first embodiment, both of magnets 12a, 12b are arranged in the rotor core to be mutually faced with each other in the radial direction of the rotor. Hence, even in a case where the number of pole pairs are set largely, the volume of rotor core 11 between both of magnets 12a, 12b does not become extremely small. Thus, the reduction in the reluctance torque can be prevented.

In addition, it is possible to increase the magnetic fluxes of magnets by arranging circumference directional magnets 14, 14 at both ends of pair of magnets 12a, 12b in the circumference (θ) direction of rotor 10. Furthermore, each portion b of rotor core 11 opposed to one of teeth portion 15 of stator 13, namely, each portion of pair of magnets 12a, 12b facing each teeth portion 15 of stator 13 may be formed of a magnetic material such as a pressure powder material and so forth. Thus, a magnetic resistance of q-axis magnetic circuit can be reduced and the reluctance torque can be utilized. In addition, a presence of circumferential magnets (14, 14) (or air gaps 14′, 14′) can prevent the magnetic flux of pair of magnets 12a, 12b from being leaked in the circumferential direction of the rotor.

It is noted that the length of each of pair of magnets 12a, 12b (this length, in this embodiment, is defined by a length from the upper edge of each of pair of magnets 12a, 12b described above to the lower edge of each of pair of magnets 12a, 12b described above (refer to FIG. 1B)) is longer than the length of rotor core 11 in the rotation axis direction of rotor 10 at a cross section of rotor core 11 cut away along the circumference direction of rotor 10 and is not at a cross section of rotor core 11 cut away along the radial direction of rotor 10. For example, in the axial gap motor (electric rotary machine), as a direction at which each magnet is arranged in an alphabetic letter V shape, two kinds of circumference direction cross section (refer to FIG. 1B) and of radial direction cross section are present. In a case where each magnet is arranged in the letter V shape at the radial direction cross section, if a number of pole pairs is increased, an angle of letter V shape becomes small so that a magnetic path cross sectional area cannot be secured and is not preferable. On the other hand, in a case where each magnet is arranged in the letter V shape at the circumference directional cross section, as in the first embodiment, a magnetic path cross section can be secured.

In the first embodiment, the length of each of pair of magnets 12a, 12b in the rotation axis direction of rotor 10 is longer than the length of the rotor core in the rotation axis direction of the rotor. In addition, as viewed from FIG. 1C, a leftward magnet group has the magnetic flux derived from N (North) poles of the pair of magnets 12a, 12b is directed at the center of portion b of rotor core 11 between pair of magnets 12a, 12b and is directed vertically toward stator 13 and a rightward magnet group has the magnetic flux entering S (South) poles of pair of magnets 12a, 12b, which is derived from the center of portion b of rotor core 11 between pair of magnets 12a, 12b, and which is derived vertically from stator 13.

### Second Embodiment

FIGS. 2A and 2B integrally show the magnet arrangement in rotor 20 of the electric rotary machine in a second preferred embodiment according to the present invention. Especially, FIG. 2A shows a cross sectional explanatory view of the electric rotary machine cut away along the rotation axis direction of rotor 20 as viewed from the radial (r) direction of the rotor and FIG. 2B shows a partial plan explanatory view of the electric rotary machine as viewed from the axial (air) gap provided between rotor 20 and stator 13. As viewed from FIGS. 2A and 2B, each of magnet group 22 is arranged in a downward faced Japanese letter of Katakana [symbol] shape in the radial (r) direction of rotor 20 (refer to FIG. 2A). Each of magnet groups 22, for example, is constituted by two pieces of magnets 22a, 22b spaced apart from each other in the radial direction (r) of rotor 20 and one piece of magnet 22c arranged at an upper position with respect to two pieces of magnets 22a, 22b to bridge between two pieces of magnets 22a, 22b. That is to say, each magnet group 22 is constituted by three pieces of magnets 22a, 22b, 22c.

Hence, portion b of rotor core 21 is arranged in the approximately rectangular shape of two pieces of magnets 22a, 22b and circumference directional magnets 14, 14 (refer to FIG. 2B) as viewed from portion b of rotor core 21. The other structure and action are the same as rotor 10 described in the first embodiment. It is noted that, in place of circumference directional magnets 14, 14 shown in FIG. 2B, air gaps 14′, 14′ may be provided at the same locations as circumference directional magnets 14, 14. In the second embodiment, the length of each magnet group 22 in the radial direction of rotor is longer than the length of rotor core 21 in the rotation axis direction of rotor 20.

### Third Embodiment

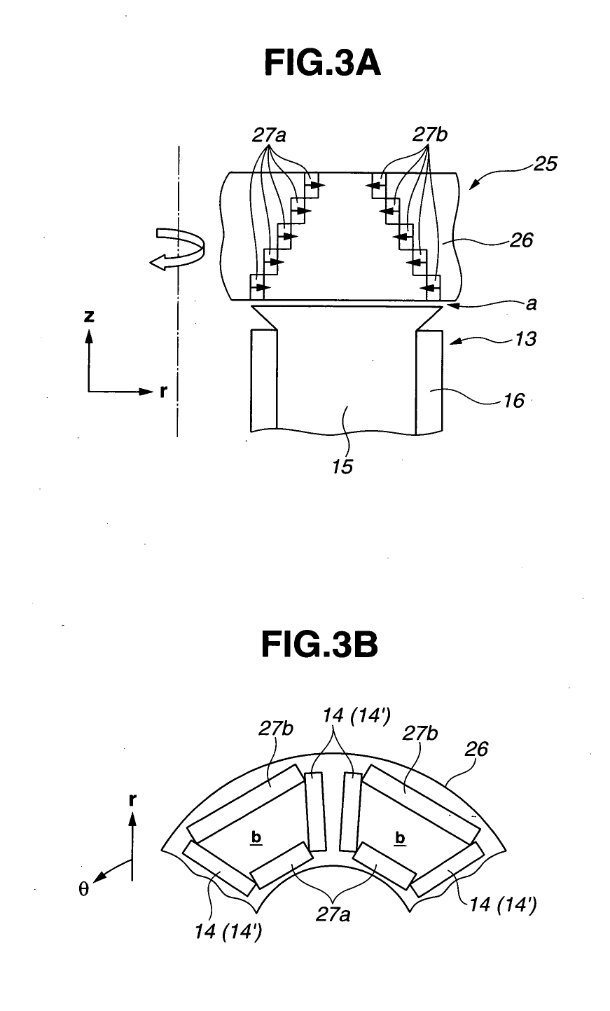

FIGS. 3A and 3B integrally show a magnet arrangement in the rotor of the electric rotary machine in a third preferred embodiment according to the present invention. Especially, FIG. 3A shows a cross sectional explanatory view of the electric rotary machine cut away along the rotation axis direction (z) of rotor 25 as viewed from the radial direction (r) of rotor 25 and FIG. 3B shows a partial plan explanatory view of the electric rotary machine as viewed from the axial (air) gap a provided between rotor 25 and stator 13 of the (axial gap) electric rotary machine. As shown in FIGS. 3A and 3B, rotor 25 of the electric rotary machine is provided with each magnet group having pair of magnets 27a, 27b, each of pair of magnets 27a, 27b having two pieces of magnets arranged in a stepwise manner arrangement (refer to FIG. 3A) in the same way as the arrangement direction of the pair of magnets 12a, 12b described in the first embodiment in place of the pair of magnets 12a, 12b. Each of pair of magnet 27a, 27b is arranged in such a way that, for example, one of two pieces of each of pair of magnets 27a, 27b is deviated in the radial direction of rotor 25 and is continuously arranged in the rotation axis direction of rotor 25 to form the stepwise magnet structure (refer to FIG. 3A).

Hence, pair of magnets 27a, 27b and circumference directional magnets 14, 14 are arranged in a rectangular shape at portion b of rotor core 26 which faces one of teeth portions 15 of stator 13 (refer to FIG. 3B). The other structure and action are the same as those described in the first embodiment (rotor 10). It is noted that circumference directional magnets 14, 14 may be replaced with air gaps 14′, 14′. In the third embodiment, the length of each of pair of magnets 27a, 27b, each magnet 27a, 27b being arranged in the stepwise manner, is longer than the length of rotor core 26 in the rotation axis direction of rotor 25. The other structure and action are the same as those described in the first embodiment.

### Fourth Embodiment

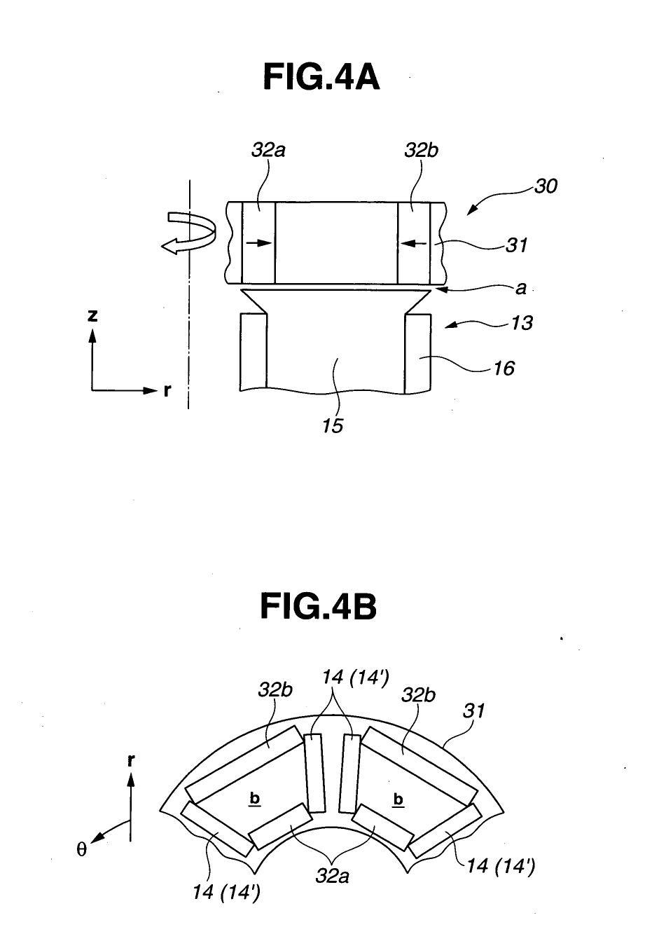

FIGS. 4A and 4B integrally show the magnet arrangement in rotor 30 of the electric rotary machine in a fourth preferred embodiment according to the present invention. Especially, FIG. 4A shows a cross sectional explanatory view of the electric rotary machine cut away along the rotation axis direction of rotor 30 as viewed from the radial direction of rotor 30 and FIG. 4B shows a partial plan explanatory view of rotor 30 as viewed from the axial (air) gap a provided between rotor 30 and stator 13. As shown in FIGS. 4A and 4B, rotor 30 of the electric rotary machine is provided with pair of magnets 32a, 32b in each of magnet groups arranged in rotor core 31, each of pair of magnets 32a, 32b being approximately vertical with respect to the front and rear surfaces of rotor 30, in place of pair of magnets 12a, 12b described in the first embodiment (refer to FIG. 4A).

Hence, pair of magnets 32a, 32b and circumference directional magnets 14, 14 are arranged in the approximately rectangular shape as viewed from portion b of rotor core 31 opposing one of each teeth portion 15 of stator 13 (refer to FIG. 4B). The other structure and action are the same as those described in the first embodiment (rotor 10). In this way, both of the pair of magnets 32a, 32b can be applied to such a case that are arranged at approximately right angles with respect to the front and rear surfaces of rotor 30 in a case where a rotation axis directional length (so-called, a rotor thickness) of rotor 30 can be taken to be longer than a radial directional length of rotor 30 (so-called, a rotor width). That is to say, pair of magnets 32a, 32b are arranged in rotor core 31 at approximately right angles with respect to the front and rear (mutually opposite) surfaces of rotor 30 in a case where the length of rotor 30 in the rotation axis direction of rotor 30 is longer than the length of rotor 30 in the radial direction of rotor 30.

As described above, in the electric rotary machine in which the rotor and the stator are arranged opposite with each other in the axial direction of the electric rotary machine, magnet groups constituted by the pair of magnets having the same polarities are arranged in the rotor core, in order for a length of each of the pair of magnets to be longer than a length of the rotor core in the rotation axis direction of the rotor and in order for a direction of each of the poles having the same polarities to become finally a direction of the stator. Thus, a surface area of each of the magnet groups is increased.

In addition, each of the pair of magnets has the length reaching the front and rear (mutually opposite) surfaces of rotor core 11 and, in the radial direction of rotor 10, the pair of magnets are faced mutually with each other and an interval of distance between edges of the pair of magnets; both of the edges facing one of the surfaces of the rotor which is opposite to axial (air) gap a to be narrower than an interval of distance between other edges of the pair of magnets facing the other of the surfaces of rotor core facing axial (air) gap a. Each of the magnet groups is constituted by pair of magnets 12a, 12b (pair of magnets 27a, 27b or pair of magnets 32a, 32b) and circumference directional magnets 14, 14 (or air gaps 14′, 14′) to direct poles of the same polarities toward the center between pair of magnets 12a, 12b. In addition, pair of magnets 32a, 32b may be arranged at approximately right angles with respect to mutually opposite (front and rear) surfaces of rotor 30 in a case where the length of the rotor in the rotation axis direction is longer than length of the rotor in the radial direction of rotor 30.

In addition, each of magnet groups is constituted by the downward faced Japanese letter of Katakana [symbol] shape in the radial direction of rotor and circumference directional magnets 14, 14 arranged at both ends of the downward faced Japanese letter of Katakana [symbol] shaped magnet 22 and the directions of poles of circumference directional magnets 14, 14 having the same polarities is toward the center of both of the pair of magnets 22, each in the downward faced Japanese letter of Katakana [symbol] shape. It is noted that circumference directional magnets 14, 14 may be replaced with air gaps 14′, 14′. Furthermore, each of the magnet groups is constituted by dome-shaped (semi-spherical) magnet 37 arranged for the same polarity poles mutually faced with each other and whose opening is faced toward the stator.

In the electric rotary machine in which the rotor and the stator are arranged opposite with each other in the axial direction of the rotary machine, each of the magnet groups constituted by the pair of magnets having the same polarities is arranged in the rotor core in order for a length of each of the pair of magnets to be longer than a length of the rotor core in the rotation axis direction of the rotor and in order for a direction of each of poles of magnets having the same polarities to become the stator direction Thus, the surface area of each of the magnets is increased. The increase in the number of poles and the increase in the magnetic fluxes of magnets can simultaneously be achieved. It is noted that rotor (10, 20, 25, 30, 35) in each of first through fifth embodiments is approximately in an annular shape in two-dimensionally or a doughnut shape (or disc shape) in three-dimensionally.

This application is based on a prior Japanese Patent Application No. 2005-292474 filed in Japan on Oct. 5, 2005, the disclosures of which are hereby incorporated by reference. Various modifications and variations can be made without departing from the scope and the spirit of the present invention.

What is claimed is:

1. An electric rotary machine, comprising:
at least one rotor including a rotor core;
at least one stator, the at least one stator facing one surface of the at least one rotor with an axial gap therebetween; and
a plurality of magnet groups, each of the magnet groups comprising a plurality of magnets having the same polarities and being arranged in the rotor core to be mutually faced with each other in a radial direction of the rotor.

2. The electric rotary machine as claimed in claim 1, wherein each of the magnets has a length reaching mutually opposite surfaces of the rotor core in the rotation axis direction of the rotor and is arranged in the rotor core in a circumference direction of the rotor, in order for an interval of distance between both edges of the magnets, both of the edges thereof facing one of the surfaces of the rotor core which is opposite to the axial gap to be shorter than another interval of distance between other edges of the magnets, both of the other edges facing the other of the mutually opposite surfaces of the rotor core faced with the axial gap; and at least one of circumference directional magnets and air gaps arranged at both ends of each of the magnets in the circumference direction of the rotor, in order for directions of the poles of the magnets having the same polarities to become equal to a center of the magnets.

3. The electric rotary machine as claimed in claim 1, wherein the magnets are arranged in the rotor core to be approximately right angles with respect to mutually opposite surfaces of the rotor in the rotation axis direction of the rotor in a case where the length of the rotor in the rotation axis direction of the rotor is longer than that in a radial direction thereof.

4. The electric rotary machine as claimed in claim 1, wherein each of the magnet groups comprises: three pieces of magnets constituting a downward faced Japanese letter of Katakana [symbol] shape in the radial direction of the rotor; and at least one of circumference directional magnets and air gaps arranged at both ends of the three pieces of magnets constituting the downward faced Japanese letter of Katakana [symbol] shape in a circumference direction of the rotor, in order for poles of the three pieces of magnets constituting the Japanese letter of Katakana [symbol] shape and having the same polarities to be oriented toward a center of the three pieces of magnets.

5. The electric rotary machine as claimed in claim 1, wherein each of the magnet groups comprises: a plurality of the magnets, each of the magnets having a length reaching mutually opposite surfaces of the rotor core in the rotation axis direction of the rotor and being arranged in a circumference direction of the rotor, in order for an interval of distance between edges of the magnets, both of the edges facing one of the surfaces of the rotor core which is opposite to the axial gap, to be shorter than another interval of distance between other edges of the magnets, both of the other edges facing the other of the surfaces of the rotor core faced with the axial gap; and circumference directional magnets arranged at both ends of each of the magnets in the circumference direction of the rotor, in order for the poles of the magnets having the same polarities to be oriented toward a center of the magnets.

6. The electric rotary machine as claimed in claim 5, wherein each of the magnet groups comprises: the three pieces of magnets constituting the downward faced Japanese letter of Katakana [symbol] shape in the radial direction of the rotor; and at least one of circumference directional magnets and air gaps arranged at both ends of the magnets constituting the downward faced Japanese letter of Katakana [symbol] shape in the circumference direction of the rotor and the length of the three pieces of the magnets constituting each of the magnet groups in the radial direction of the rotor is longer than the length of the rotor core in the rotation axis direction of the rotor.

7. The electric rotary machine as claimed in claim 1, wherein each of the magnet groups comprises: a plurality of the magnets, each of the magnets having the length reaching mutually opposite surfaces of the rotor core in the rotational axis direction of the rotor and being arranged in a circumference direction of the rotor, in order for an interval of distance between edges of the magnets, both of the edges facing one of the surfaces of the rotor core which is opposite to the axial gap to be shorter than that between other edges of the magnets, both of the other edges thereof facing the other of the surfaces of the rotor core facing the axial gap; and air gaps arranged at both ends of each of the magnets in the circumference direction of the rotor in order for the poles of the magnets to be oriented toward a center of the magnets.

8. The electric rotary machine as claimed in claim 1, wherein each of the magnet groups comprises: three pieces of magnets constituting a downward faced Japanese letter of Katakana [symbol] shape in the radial direction of the rotor; and air gaps arranged at both ends of the magnets constituting the downward faced Japanese letter of Katakana [symbol] shape in a circumference direction of the rotor, in order for poles of the magnets constituting the Japanese letter of Katakana [symbol] shape to be oriented toward a center between the two pieces of the magnets located at both sides of the remaining piece of the magnets constituting the downward faced Japanese letter of Katakana [symbol] shape in the radial direction of the rotor.

9. The electric rotary machine as claimed in claim 1, wherein each of the magnet groups comprises the magnets, each of which being of an approximately rectangular shape as viewed from a portion of the rotor core which is a center between the magnets, both in a circumference direction of the rotor and in a radial direction thereof.

10. The electric rotary machine as claimed in claim 1, wherein the magnets, each length of the magnets in the rotation axis direction of the rotor being longer than the length of the rotor in the rotation axis direction of the rotor, faces an upper end surface of each teeth portion of the at least one stator via the axial gap.

11. The electric rotary machine as claimed in claim 3, wherein a pole of one of the magnets is faced with another pole of the other of the magnets, both of the pole and the other pole having the mutually same polarities, in an approximately parallel to each other in the case where the length of the rotor in the rotation axis direction of the rotor is longer than that in the radial direction thereof.

12. The electric rotary machine as claimed in claim 11, wherein a lower end of each of the magnets is arranged to face an upper end surface of each teeth portion of the stator as viewed from the rotation axis direction of the rotor.

13. The electric rotary machine as claimed in claim 4, wherein the three pieces of magnets constituting the downward faced Japanese letter of Katakana [symbol] shape in the radial direction of the rotor includes two pieces of magnets located at both ends of another piece of magnet to bridge the other piece of magnet in the radial direction of the rotor, the length of the three pieces of the magnets in the radial direction of the rotor being longer than the length of the rotor in the rotation axis of the rotor.

14. The electric rotary machine as claimed in claim 13, wherein the three pieces of magnets constituting the downward faced Japanese letter of Katakana [symbol] shape are arranged to face an upper surface of each teeth portion of the stator via the axial gap.

15. The electric rotary machine as claimed in claim 1, wherein the magnets of each of the magnet groups are of a Japanese letter of Katakana [symbol] shape in the radial direction of the rotor.

16. The electric rotary machine as claimed in claim 1, wherein each of the magnets includes mutually deviated two pieces of magnets in the radial direction of the rotor arranged in a stepwise manner and arranged in a continuous manner in the rotation axis direction of the rotor, the length of the two pieces of the magnets in the rotation axis direction of the rotor being longer than the length of the rotor in the rotation axis direction thereof.
